(19) United States
(12) Patent Application Publication
(10) Pub. No.: US 2006/0096445 A1
(43) Pub. Date: May 11, 2006

(54) Entertainment display systems

(76) Inventor: Cary H. Leach, Phoenix, AZ (US)

Correspondence Address: STONEMAN LAW OFFICES, LTD, 3113 NORTH 3RD STREET, PHOENIX, AZ, 85012, US

(21) Appl. No.: 11/270,118

(22) Filed: Nov. 8, 2005

Related U.S. Application Data
(60) Provisional application No. 60/626,842, filed on Nov. 10, 2004.

(51) Int. Cl. G10D 9/00

(52) U.S. Cl. 84/453

(57) ABSTRACT

An analog to digital system for improved audio driven control of electrical devices, especially those relating to synchronizing lighting displays to music. Methods relating to modular system designs used to produce pleasurable visual effects responsive to analog music sounds are also disclosed.

### CROSS-REFERENCE TO RELATED APPLICATION

The present application is related to and claims priority from prior provisional application Ser. No. 60/626,842, filed Nov. 10, 2004, entitled “ENTERTAINMENT DISPLAY SYSTEMS”, the contents of which are incorporated herein by this reference and are not admitted to be prior art with respect to the present invention by the mention in this cross-reference section.

### BACKGROUND

This invention relates to providing systems for improved audio driven control of electrical devices, especially those relating to entertainment lighting displays synchronized to music. The use of frequency-isolated audio signals to control lighting or electromechanical devices has a large number of beneficial applications. For example, the presence of a specific frequency within an audio signal may be used to trigger a child's toy, or a musician may use the presence of specific audio frequencies to control stage lighting during a performance. In improvisational musical performances, such as during a jazz concert, it is impractical or impossible to pre-program a dynamic lighting display to respond to the spontaneous structure of the music. Clearly, near-instantaneous audio processing with an associated electrical device control feature would be of great value in producing many types of improvisational musical performances.

No device exists to inexpensively and accurately discriminate very narrow frequency band(s) within an audio signal, and to process such signal(s) to provide a trigger for one or more electrical devices. It is clear that development of highly efficient, accurate, and inexpensive audio control systems of this type would benefit many.

### OBJECTS AND FEATURES OF THE INVENTION

A primary object and feature of the present invention is to provide a system to solve the above-mentioned problems and meet the above-mentioned needs.

Another primary object and feature of the present invention is to provide a system for producing, from at least one analog input signal comprising at least one wide frequency band of sound, at least one trigger signal corresponding to presence of at least one selected narrow frequency band of sound.

It is a further object and feature of the present invention to provide such a system having at least one display controller adapted to provide electrical control of at least one powered entertainment display such as colored lights.

It is a further object and feature of the present invention to provide such a system having a plurality of controller stages wherein each one of such plurality of controller stages is electro-optically coupled to at least one of such plurality of frequency filter stages.

It is a further object and feature of the present invention to provide such a system having at least one controllable effects generator adapted to generate at least one controllable illumination effect at the at least one illumination source.

It is a further object and feature of the present invention to provide a novel method of providing a trigger voltage to a phased controlled integrated circuit using a trigger voltage, supplied by optical coupling, and a user adjustable reference voltage.

It is a further object and feature of the present invention to provide a method, relating to modular design to produce pleasurable visual effects responsive to analog music sounds.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides circuit apparatus, relating to providing, from at least one analog input signal comprising at least one wide frequency band of sound, at least one trigger signal corresponding to presence of at least one selected narrow frequency band of sound, comprising: analog receiver means for receiving such at least one wide frequency band of sound; first band pass filter means for filtering such at least one wide frequency band of sound to select at least one first narrow frequency band of sound having a wider band than at least one second narrow frequency band of sound; second band pass filter means for filtering such at least one first narrow frequency band of sound to select such at least one second narrow frequency band of sound having a wider band than such at least one selected narrow frequency band of sound; voltage-comparator filter means, having a settable reference voltage usable to further narrow such at least one second narrow frequency band of sound, for filtering by voltage comparator to select such at least selected narrow frequency band of sound; and translator means for providing, for use as such at least one trigger signal, at least one direct-current signal corresponding to such presence of such at least one selected narrow frequency band of sound.

Moreover, it provides such a circuit apparatus wherein such voltage-comparator filter means comprises analog to square wave converter means for converting such at least selected narrow frequency band of sound of such at least one analog input signal to at least one fixed amplitude square wave signal. Additionally, it provides such a circuit apparatus wherein: such analog to square wave converter means comprises signal amplitude selector means for holding such at least one fixed amplitude square wave signal active over at least one selected portion of the amplitude of such at least one second narrow frequency band of sound; and such at least one selected portion of the amplitude of such at least one second narrow frequency band of sound is selected by setting such settable reference voltage. Also, it provides such a circuit apparatus wherein such settable reference voltage is settable by a user. In addition, it provides such a circuit apparatus wherein such translator means comprises direct-current rectifier means for outputting at least one direct-current signal corresponding to the presence of such at least one fixed amplitude square wave signal. And, it provides such a circuit apparatus wherein such direct-current rectifier means comprises signal sustainer means for sustaining such at least one direct-current signal over at least one minimum ergonomic duration related to human vision persistence.

Further, it provides such a circuit apparatus wherein such translator means further comprises voltage level shifter means for shifting a nominal voltage level of such at least one direct-current signal to about at least one standard logic voltage level. Even further, it provides such a circuit apparatus wherein such translator means further comprises voltage level shifter means for shifting a nominal voltage level of such at least one direct-current signal to a transistor-transistor logic level of more than about four volts and less than about six volts. Moreover, it provides such a circuit apparatus wherein such translator means further comprises: current amplifier means for amplifying the current of such at least one direct-current signal having at least one standard logic voltage; wherein the output of such current amplifier means comprises such at least one trigger signal.

Additionally, it provides such a circuit apparatus wherein such analog receiver means comprises preamplifier means for preamplifying such at least one analog input signal prior to frequency filtering. Also, it provides such a circuit apparatus wherein: such analog receiver means further comprises input level adjuster means for adjusting such at least one analog input signal to establish at least one compatible signal level at such first band pass filter means; and such analog receiver means further comprises impedance matching means for impedance matching such at least one analog input signal to such input level adjuster means.

In addition, it provides such a circuit apparatus further comprising: display controller means for assisting control of at least one powered entertainment display; wherein control of the at least one powered entertainment display by such display controller means is triggered by such at least one trigger signal. Circuit apparatus, relating to providing, from at least one analog input signal comprising at least one wide frequency band of sound, at least one trigger signal corresponding to presence of at least one selected narrow frequency band of sound, comprising: at least one analog receiver adapted to receive such at least one wide frequency band of sound; at least one first band pass filter adapted to filter such at least one wide frequency band of sound to select at least one first narrow frequency band of sound having a wider band than at least one second narrow frequency band of sound; at least one second band pass filter adapted to filter such at least one first narrow frequency band of sound to select such at least one second narrow frequency band of sound having a wider band than such at least one selected narrow frequency band of sound; at least one voltage-comparator filter, having at least one settable reference voltage usable to further narrow such at least one second narrow frequency band of sound, adapted to filter by voltage comparator to select such at least selected narrow frequency band of sound; and at least one translator circuit adapted to provide, for use as such at least one trigger signal, at least one direct-current signal corresponding to such presence of such at least one selected narrow frequency band of sound. And, it provides such a circuit apparatus further comprises: a plurality of frequency filter stages electrically coupled to such at least one analog receiver; wherein each one of such plurality of frequency filter stages comprises such at least one first band pass filter, such at least one second band pass filter, such at least one voltage-comparator filter, and such at least one translator circuit; and wherein each one of such plurality of frequency filter stages is adapted to provide at least one additional trigger signal corresponding to presence of at least one additional selected narrow frequency band of sound.

Further, it provides such a circuit apparatus wherein such at least one voltage-comparator filter comprises at least one analog to square wave converter adapted to convert such at least selected narrow frequency band of sound of such at least one analog input signal to at least one fixed amplitude square wave signal. Even further, it provides such a circuit apparatus wherein such at least one analog to square wave converter comprises: at least one signal amplitude selector adapted to hold such at least one fixed amplitude square wave signal active over at least one selected amplitude portion of such at least one second narrow frequency band of sound; wherein such at least one selected amplitude portion of such at least one second narrow frequency band of sound is selected by setting such settable reference voltage.

Moreover, it provides such a circuit apparatus wherein such settable reference voltage is settable by a user. Additionally, it provides such a circuit apparatus wherein such at least one translator circuit comprises at least one direct-current rectifier adapted to output at least one direct-current signal corresponding to the presence of such at least one fixed amplitude square wave signal. Also, it provides such a circuit apparatus wherein such at least one direct-current rectifier comprises at least one direct-current signal sustainer adapted to sustain such at least one direct-current signal over at least one minimum ergonomic duration related to human vision persistence.

In addition, it provides such a circuit apparatus wherein such at least one translator circuit further comprises at least one voltage level shifter adapted to shift a nominal voltage level of such at least one direct-current signal to about at least one standard logic voltage level. And, it provides such a circuit apparatus wherein such at least one translator circuit further comprises at least one voltage level shifter adapted to shift a nominal voltage level of such at least one direct-current signal to a transistor-transistor logic level of more than about three volts and less than about six volts.

Further, it provides such a circuit apparatus wherein such at least one translator circuit further comprises: at least one current amplifier adapted to amplify the current of such at least one direct-current signal having at least one standard logic voltage; wherein the output of such at least one current amplifier comprises such at least one trigger signal. Even further, it provides such a circuit apparatus wherein such at least one analog receiver comprises at least one preamplifier adapted to pre-amplify such at least one analog input signal from a line level to a first output gain prior to frequency filtering. Moreover, it provides such a circuit apparatus wherein such at least one analog receiver further comprises at least one filter driver adapted to amplify such at least one analog input signal from such first output gain to a second output gain compatible with the operation of such at least one first band pass filter.

Additionally, it provides such a circuit apparatus further comprising: at least one display controller adapted to provide electrical control of at least one powered entertainment display; wherein electrical control of the at least one powered entertainment display by such at least one display controller is triggerable by such at least one trigger signal. Also, it provides such a circuit apparatus wherein such at least one display controller comprises at least one phased controlled integrated circuit adapted to regulate at least one flow of electrical current to such at least one powered entertainment display. In addition, it provides such a circuit apparatus wherein such at least one display controller comprises at least one electro-optical coupler adapted to receive the at least one trigger signal by electro-optical coupling. And, it provides such a circuit apparatus wherein such at least one display controller is adapted to electrically control the illumination of at least one illumination source.

Further, it provides such a circuit apparatus further comprising: a plurality of controller stages; wherein each one of such plurality of controller stages is electro-optically coupled to at least one of such plurality of frequency filter stages; and wherein each one of such plurality of controller stages is adapted to provide electrical control of at least one powered entertainment display in response to the at least one trigger signal generated by such at least one of such plurality of frequency filter stages. Even further, it provides such a circuit apparatus wherein: each one of such plurality of controller stages is adapted to electrically control such at least one illumination source; and such at least one illumination source comprises a visually distinct color. Moreover, it provides such a circuit apparatus wherein such at least one display controller further comprises: at least one controllable effects generator adapted to generate at least one controllable illumination effect at the at least one illumination source; wherein such at least one controllable effects generator comprises at least one user control adapted to permit user initiated control of at least one feature of such at least one controllable illumination effect.

Additionally, it provides such a circuit apparatus wherein such at least one controllable effects generator comprises: at least one decade counter adapted to provide at least one logic pulse; wherein such at least one decade counter is structured and arranged to control such plurality of controller stages in at least one serial order to provide at least one sequenced illumination effect. Also, it provides such a circuit apparatus wherein such plurality of controller stages comprises a physically separate modular circuit board. In addition, it provides such a circuit apparatus wherein such physically separate modular circuit board comprises at least five of such plurality of controller stages. And, it provides such a circuit apparatus wherein such plurality of frequency filter stages comprises a physically separate modular circuit board. Further, it provides such a circuit apparatus wherein each physically separate modular circuit board comprises at least five of such plurality of frequency filter stages.

In accordance with a preferred method hereof, this invention provides a method of providing a trigger voltage to a phased controlled integrated circuit adapted to power at least one entertainment display system, comprising the steps of: providing at least one direct-current reference voltage having at least one direct-current trigger voltage superimposed therein; wherein such at least one direct-current trigger voltage is supplied by optical coupling from at least one external trigger source; and wherein such at least one direct-current reference voltage is adjustable by a user.

In accordance with another preferred method hereof, this invention provides a method, relating to modular design to produce pleasurable visual effects responsive to analog music sounds, comprising the steps of: designing at least one modular electronic architecture providing filtering of such analog music sounds into at least five narrow frequency bands by at least five frequency-selectable filtering circuits; wherein each of such at least five frequency-selectable filtering circuits comprise essentially the same circuits but for frequency-selecting values; and wherein essentially all electronic components used in such designing of such at least one architecture comprise standard off-the-shelf electronic components; and selecting at least five different visual effects, each designed to be triggerable by presence of selectable minimums of sound narrowly adjacent at least one selected sound frequency; and assigning each visual effect of such at least five different visual effects to at least one of such at least five narrow frequency bands; wherein such at least one modular electronic architecture assists ease of variability in assigning such at least five narrow-frequency bands to maximize visual pleasure from each of a variety of particular kinds of music sounds.

Even further, it provides such a method wherein such at least five different visual effects comprise selected colors of light. Even further, it provides such a method wherein such triggerability is designed, working within parameters of human visual systems, to produce essentially only light pulses of sufficient length to be seen as a full-color effect and brightness for each such selected color of light. Even further, it provides such a method wherein such at least five narrow-frequency bands are selected to correlate with at least one fundamental frequency of at least one source of musical sound. Even further, it provides such a method wherein such at least one source of musical sound comprises at least one musical instrument.

Moreover, it provides such a method further comprising the step of designing at least one light display matched for plug-in use with such at least one modular electronic architecture. Even further, it provides such a method further comprising the step of designing at least one light display matched for plug-in use with such at least one modular electronic architecture. Further, it provides such a method further comprising the step of manufacturing such designed at least one modular electronic architecture and such at least one light display. Even further, it provides such a method further comprising the step of offering such manufactured such designed at least one modular electronic architecture and such at least one light display for sale to businesses desiring a professional-quality color organ at non-custom pricing.

Even further, it provides such a method wherein such businesses comprise musical entertainment sources providing instant selectability of musical numbers. Even further, it provides such a method further comprising the step of manufacturing such designed at least one modular electronic architecture.

In accordance with another preferred embodiment hereof, this invention provides a method, relating to producing pleasurable visual effects responsive to analog music sounds, comprising the steps of: analyzing at least one entertainment market desiring digital-quality sound separation devices adaptable to a wide variety of analog musical pieces and buyable within analog, non-custom pricing; and designing a plurality of entertainment products each utilizing at least one essentially-analog sound separation device using essentially off-the shelf circuit components and providing essentially digital-quality sound separation; wherein such designing uses modular design and manufacturing techniques to provide a variety of different price range such entertainment products; and wherein each such at least one essentially-analog sound separation device comprises filtering distinguishing at least five different narrow-frequency bands. Even further, it provides such a method further comprising manufacture and sale of such entertainment products. Even further, it provides such a method wherein such entertainment products comprise color organs.

In accordance with all preferred embodiments hereof, this invention provides each and every novel feature, element, combination, step and/or method disclosed or suggested by this provisional patent application.

### DEFINITIONS, ACRONYMS AND CROSS-REFERENCES

Bandpass Filter: A frequency filter adapted to pass one band of frequency while rejecting both higher and lower frequencies. An ideal bandpass filter passes all frequencies between two non-zero finite limits and rejects all frequencies not within such limits.

Color Organ: A lighting device in the past typically having three to four audio channels, each channel having crude sensitivity to a broad frequency range. For example, a low frequency range might illuminate a red light, a mid frequency range might illuminate yellow light, and a high frequency range might illuminate a blue light. “Color Organ”, in referring to applicant's within preferred embodiments, includes such lighting systems with any number of audio channels and high sensitivity to a narrow frequency range.

DC: In the present disclosure, the term “DC” is an abbreviation for Direct Current.

Filter Q: In the present disclosure, the Q of a filter is defined as the center frequency divided by the bandwidth.

Op-amp: The term “Op-amp” is an abbreviation for operational amplifier, a class of high-gain DC-coupled amplifiers with two inputs and a single output.

RCA: In the present disclosure, “RCA” refers to a plug and a jack designed for use with audio coaxial cable.

Triac: An electronic component equivalent to two silicon controlled rectifiers joined end to end (or back to back) with their gates electrically coupled. This arrangement results in a bi-directional electronic switch which conducts current in both directions when the gate is triggered.

TTL: In the present disclosure the term “TTL” is an abbreviation for transistor-transistor logic. “TTL voltage” generally refers to a logic high input signal of between about 2.0 V to about 5.5 V and logic low input of between 0 V to about 0.8 V.

### BRIEF DESCRIPTION OF THE DRAWINGS

FIG. 1 shows a perspective view of an entertainment and audio display system, driving a stage lighting display, according to a preferred embodiment of the present invention.

FIG. 2a shows a block diagram illustrating a preferred sequence of signal processors comprising a single filter channel of the embodiment of FIG. 1.

FIG. 2b shows a block diagram illustrating a preferred arrangement of components comprising a single dimmer module of the embodiment of FIG. 1.

FIG. 3 shows a circuit schematic illustrating a preferred embodiment of a filter driver board according to the embodiment of FIG. 2a.

FIG. 4 shows a circuit schematic illustrating a preferred embodiment of a dimmer module, used to control the operation of a lighting display, according to the embodiment of FIG. 2b.

FIG. 5 shows a block diagram illustrating the filter driver circuit and the wave forms produced by each component or sub-circuit according to the embodiment of FIG. 2a.

FIG. 6a shows a diagram illustrating a preferred embodiment of a system motherboard according to the preferred embodiment of FIG. 1.

FIG. 6b shows a schematic diagram illustrating a system power supply of the system motherboard according to the preferred embodiment of FIG. 6a.

FIG. 6c shows a schematic diagram illustrating an effects circuit of the system motherboard according to preferred embodiment of FIG. 6a.

FIG. 7 shows an exploded view generally illustrating the modular components of the audio display system according to the embodiment of FIG. 1.

FIG. 8 shows a diagram illustrating a method, relating to modular design to produce pleasurable visual effects responsive to analog music sounds, according to the present invention.

FIG. 9 shows a diagram illustrating a method, relating to producing pleasurable visual effects responsive to analog music sounds.

### DETAILED DESCRIPTION OF THE BEST MODES AND PREFERRED EMBODIMENTS OF THE INVENTION

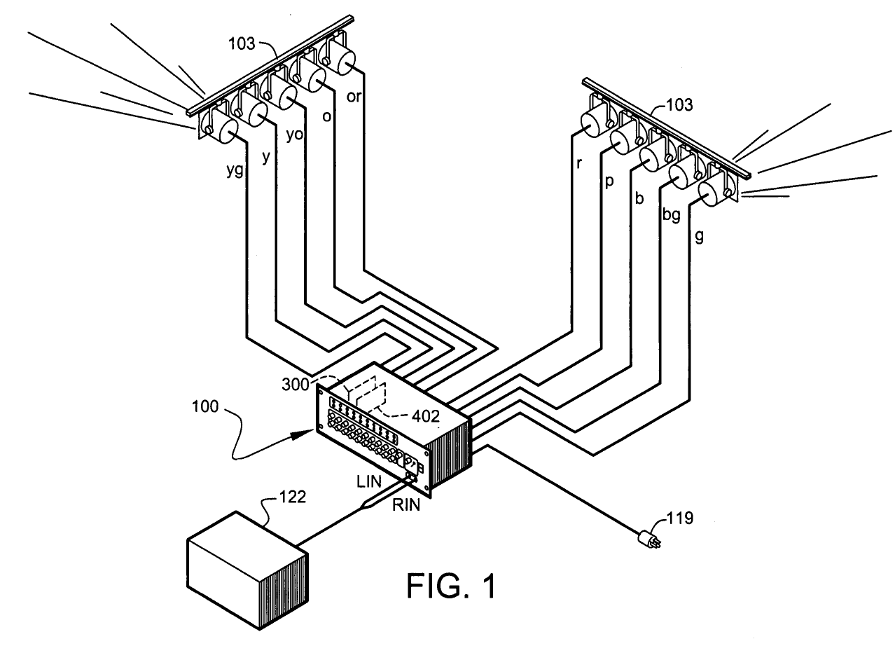

FIG. 1 shows a perspective view of audio display system 100, driving lighting display 103, according to a preferred embodiment of the present invention. Preferably, audio display system 100 is adapted to receive an audio signal from right and left audio channels of analog audio source 122, as shown. Analog audio source 122 may preferably comprise an amplified device such as a home entertainment system. Audio may also be derived from range of other sources, such as a mixer board, a splitter box or directly from an amplified instrument. Preferably, a filter driver board 300 (indicated in dashed lines) within audio display system 100 is adapted to precisely separate the incoming analog audio signal, by frequency range, into a plurality of audio processing channels. Each audio processing channel is adapted to output a TTL direct-current trigger signal. The direct-current trigger signal produced by filter driver board 300 is ideal for providing trigger data to a wide range of device controller circuits including the on-board dimmer module board 402 (indicated with dashed lines), used to control lighting display 103, as shown.

The precision frequency discrimination capability of audio display system 100 permits the system to provide a high degree of device controller responsiveness. For example, in the embodiment of FIG. 1, where audio display system 100 is adapted to control a display of ten multi-colored lights, the large number of frequency bands, resolved by the system, can be assigned to an equally large number of visually unique colors, thus producing a lighting display of high visual interest. Furthermore, the preferred precision frequency discrimination capability of audio display system 100 permits the system to be flexibly tailored to a specific musical performance or genre. For example, audio display system 100 is selectively adjustable to respond to the higher frequency ranges of a string quartet, or to the lower frequency ranges of a rap group.

Audio display system 100 preferably comprises additional features adapted to provide advanced light controller functions. Preferably, audio display system 100 comprises an on-board light chaser circuit to provide enhanced visual interest. Preferably, audio display system 100 is adaptable to include such diverse display effects as timers, sequencers, faders, sweeps, etc. Preferably, audio display system 100 comprises AC power input 119 for powering both the internal electronics of the system and lighting display 103 controlled by the system. Preferably, the rear panel of audio display system 100 comprises a plurality of electrical sockets to permit plug-in connections for the wire conductors routed to lighting display 103, as shown. Upon reading the teachings of this specification, those with ordinary skill in the art will now understand that, under appropriate circumstances, considering such issues as advances in technology, user preference, etc., other connection arrangements, such as combined conductors, addressable devices permitting a single conductor to fire a selected light, wireless light control arrangements, etc., may suffice.

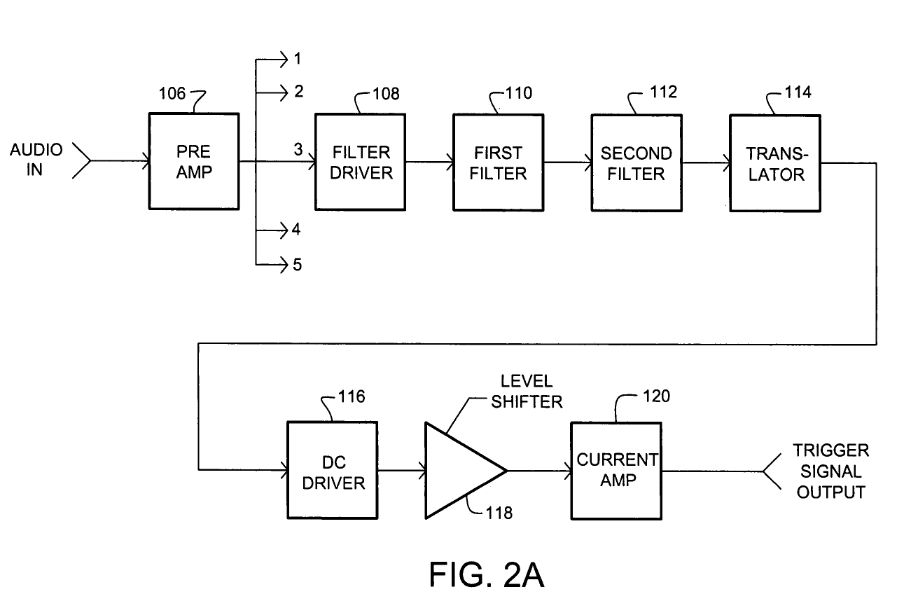

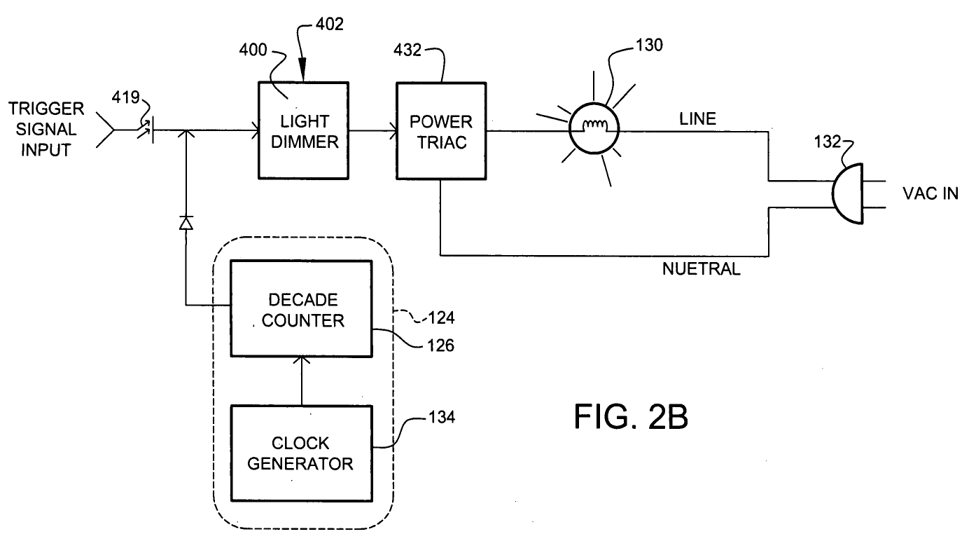

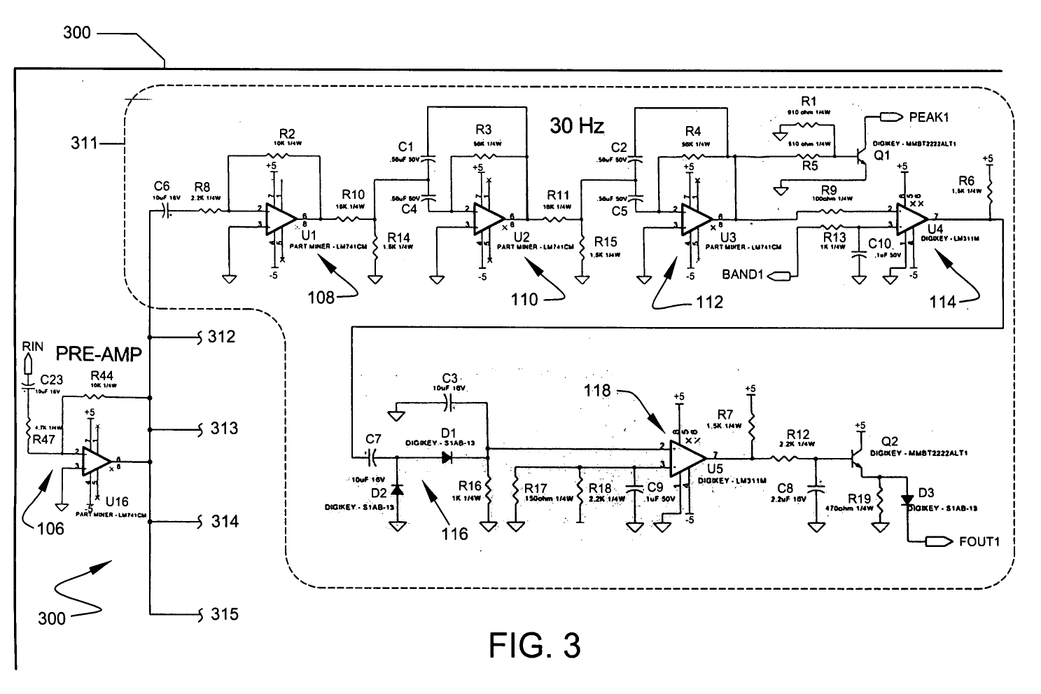

FIG. 2a shows a block diagram illustrating a preferred sequence of signal processors comprising a single filter channel of filter driver board 300 of FIG. 1. Preferably, analog audio signal, at the input point designated as AUDIO INPUT (for example, right channel in RIN or left channel in LIN), is fed into line level preamp 106 and buffered to a group of five filter driver pathways (for clarity, only one filter driver pathway is illustrated—see FIG. 3 for an expanded description of specific circuiting). Each filter driver pathway preferably comprises filter driver 108 adapted to set different peaks of audio frequencies. Preferably, filter driver 108 is coupled to an active bandpass filtering stage wherein the signal is processed through first bandpass filter 110 (at least embodying herein first band pass filter means for filtering such at least one wide frequency band of sound to select at least one first narrow frequency band of sound having a wider band than at least one second narrow frequency band of sound) and second bandpass filter 112 (at least embodying herein second band pass filter means for filtering such at least one first narrow frequency band of sound to select such at least one second narrow frequency band of sound having a wider band than such at least one selected narrow frequency band of sound), as shown. It is at the bandpass filter stage that audio display system 100 becomes highly selective to the detection of specific audio frequencies.

Preferably, a peak amplitude signal is created at translator 114 when the center frequency of the filter bank is superimposed over the audio frequency to form a square wave. Preferably, this square wave remains present by varying a DC control voltage set at translator 114 (at least embodying herein voltage-comparator filter means, having a settable reference voltage usable to further narrow such at least one second narrow frequency band of sound, for filtering by voltage comparator to select such at least selected narrow frequency band of sound). Preferably, the lower the DC voltage that is set into translator 114, the longer the square wave is present over the slope of the filter (effectively increasing the bandwidth response of the circuit). Following translator 114 is DC rectifier circuit 116, which creates a low level DC signal as long as the square wave generated by translator 114 is present. If the square wave is not present, the signal level equals zero volts.

Preferably, the low level DC signal generated by DC rectifier circuit 116 is then amplified to a full TTL level (five-volt signal is high and zero is low) at level shifter 118. This TTL level DC signal is then current-amplified by current amplifier 120 (essentially an emitter follower arrangement) to produce a final trigger signal output (this rectifier/amplifier arrangement at least embodies herein translator means for providing, for use as such at least one trigger signal, at least one direct-current signal corresponding to such presence of such at least one selected narrow frequency band of sound).

FIG. 2b shows a block diagram illustrating a preferred arrangement of components comprising a single dimmer module of the embodiment of FIG. 1. In a preferred embodiment of the present invention, the trigger signal generated at filter driver board 300 is passed, via optocoupler 419, to dimmer module 400 of dimmer module board 402, as shown. Preferably, the phase-controlled circuitry of dimmer module 400 is driven to produce full brightness at light 130 when the logic level at optocoupler 419 is high. In operation, a high trigger signal logic level at optocoupler 419 offsets the dimmer bias point, prompting phase control IC 430 to send a trigger signal to the gate terminal of triac 432. Preferably, triac 432 is electrically coupled to line load power source 132, and controls the passage of current to light 130, as shown.

In addition, audio display system 100 preferably comprises effects circuit 124 adapted to provide complex illumination effects during operation. Preferably, effects circuit 124 comprises decade counter 126 coupled to clock generator 134, as shown. Preferably, logic is pulsed from decade counter 126 to produce a “marquee effect” when used with several lighting channels in a serial order.

FIG. 3 shows a circuit schematic illustrating a preferred embodiment of filter driver board 300 of the present invention. Preferably, filter driver board 300 comprises a single, line-level pre-amplifier (hereinafter “pre-amp”) 106 driving inputs for up to five individually tuned filter drivers 311, 312, 313, 314, and 315 (at least embodying herein a plurality of frequency filter stages electrically coupled to such at least one analog receiver). Pre-amp 106 preferably receives an audio signal, such as that produced by a home entertainment center, at the input coupling designated RIN (at least embodying herein analog receiver means for receiving such at least one wide frequency band of sound) and provides a gain of about 2 to the input signal.

Pre-amp 106 is preferably based on an LM741CM operational amplifier U16 in a differentiator circuit configuration, as shown, that provides a substantially constant gain of 2 over the input audio signal frequencies. The LM741CM operational amplifier is an 8-pin integrated circuit available from PartMiner, Inc., of Melville, N.Y. Power is preferably supplied to operational amplifier U16 as nominally +5 volts at the +V input (pin 7) and nominally −5 volts at the −V input (pin 4). The gain of pre-amp 106 is established primarily by the 10,000-ohm, ¼-watt, feedback resistor R44, while the frequency at which the gain curve flattens is established by the 10-microfarad 16-volt input capacitor C23. The 4700-ohm, ¼-watt input resistor R47 substantially prevents ringing and oscillation otherwise created by the input capacitor C23 and also establishes an input impedance for pre-amp 106 along with input capacitor C23. Input resistor R47 also contributes to the gain determination. Preferably, pre-amp 106 is an inverting amplifier, with the input audio signal applied to the inverting input (pin 2) of operational amplifier U16, as shown. Preferably, the non-inverting input (pin 3) of the operational amplifier U16 is connected to ground to complete the differentiator circuit configuration. Preferably, the inverted output signal is taken from pin 6 of operational amplifier U16 and sent to each individually-tuned filter driver circuit 311 through 315, as shown. Those skilled in the art, upon reading the teachings of this specification, will appreciate that, under appropriate circumstances, considering such issues as economics, improvements in operational amplifiers, and improvement in circuit manufacturing, other pre-amps, such as those with higher gain, lower cost, etc., may be used with filter driver board 300.

Preferably, filter driver circuit 311 comprises seven stages connected in series, as shown. Preferably, the first stage, filter driver 108, comprises an inverting operational amplifier U1 in a differentiator configuration similar to pre-amp 106 but with the input resistor R8 sized as 2200 ohms (¼ watt) for impedance matching with pre-amp 106. Filter driver 108 preferably includes LM741CM operational amplifier U1 powered by +/−5 volts at pins 7 and 4, respectively. Preferably, input capacitor C6 is sized as 10 microfarads (16 volts) to flatten the gain curve of filter driver 108 over the same audio input frequencies as pre-amp 106 produced. Feedback resistor R2 is preferably sized at nominally 10,000 ohms (¼ watt) to establish, along with resistor R8, a nominal gain of about 5 over the input audio frequencies. Preferably, the non-inverting input (pin 3) of operational amplifier U1 is connected to ground to complete the differentiator configuration of filter driver 108, as shown. Preferably, the output resistor pair R10 and R14 establish the output signal from pin 6 of inverting amplifier 108 at their junction while assisting in the impedance match to the second stage: first bandpass filter 110. Having been inverted twice, the output signal of the filter driver 108 has the same polarity as the input audio signal at coupling RIN. Those skilled in the art, upon reading the teachings of this specification, will appreciate that, under appropriate circumstances, considering such issues as economics, improvements in operational amplifiers, and improvement in circuit manufacturing, other filter drivers, such as those with higher gain, lower cost, adjustable resistors and capacitors, etc., may be used with filter driver board 300.

Preferably, the output signal from filter driver 108 is coupled to the input of first bandpass filter 110. First bandpass filter 110 is preferably a multiple feedback active bandpass filter, as shown. Operational amplifier U2 is preferably an LM741CM operational amplifier in an active bandpass filter configuration. Preferably, feedback resistor R3 and feedback capacitor C4 form a differentiator-like, high-pass circuit while feedback capacitor C1 and resistors R10 (preferably 18,000 ohms) and R14 (preferably 1200 ohms) form an integrator-like, low pass circuit. Feedback resistor R3 is preferably sized to be nominally 56,000 ohms and feedback capacitors C1 and C4 are preferably both nominally 56 microfarads (60 volts), as shown. Taking C=C1+C4 and considering R10 and R14 as being in parallel to be Rₛᵤₘ, the relevant parameters of the first bandpass filter 110 are:

$$\begin{matrix}fo = \frac{1}{2 π \cdot C \sqrt{{R}_{sum} \cdot {R}_{3}}} = ∼ 30 Hz , for center frequency , \\ Q = \frac{1}{2} \sqrt{\frac{{R}_{3}}{{R}_{sum}}} = ∼ 3.5 , for peak quality , and \\ BW = \frac{2}{{R}_{sum} C} = ∼ 16 Hz , for bandwidth .\end{matrix}$$

Preferably, operational amplifier U2 is powered by +5 volts on the +V input pin 7 and −5 volts on the −V input pin 4. Preferably, the non-inverting input at pin 3 is coupled to ground to complete the multiple feedback active bandpass filter configuration. The output signal of the lead bandpass filter 110 is a sample of the input signal about the center frequency of 30 Hz having a bandwidth of about 16 Hz and having a Q of about 3.5. The output signal of the first bandpass filter 110 is coupled to the second bandpass filter 112. Those skilled in the art, upon reading the teachings of this specification, will appreciate that, under appropriate circumstances, considering such issues as economics, improvements in operational amplifiers, and improvement in circuit manufacturing, other bandpass filters, such as those with higher gain, lower cost, adjustable resistors and capacitors, etc., may be used with filter driver board 300.

Preferably, second bandpass filter 112 is identical to first bandpass filter 108 except that a portion of the output is coupled to transistor Q1 through biasing resistors R5 and R1 to switch on a light-emitting diode coupled to output coupling PEAK1. Resistor R5 is preferably 910 ohms and resistor R1 is preferably 510 ohms, as shown. Both resistors R5 and R1 are preferably ¼ watt resistors, as shown. Resistors R1 and R5 bias the signal voltage to within the operating limits of the transistor Q1. Preferably, the emitter of transistor Q1 is coupled to ground, as shown. Transistor Q1 is preferably part number MMBT2222ALT1 from Digi-key, Inc., of Thief River Falls, Minn., as shown. The light emitting diode is preferably a front-panel indicator that provides a user with an indication of when the output signal of second bandpass filter 112 is above its half-power points. Thus, a backstage production engineer can monitor performance without seeing the onstage display. Those skilled in the art, upon reading the teachings of this specification, will appreciate that, under appropriate circumstances, considering such issues as economics, improvements in operational amplifiers, and improvement in circuit manufacturing, other bandpass filters, such as those with higher gain, lower cost, adjustable resistors and capacitors, etc., may be used with filter driver board 300.

The output signal from second bandpass filter 112 is an audio sample peak centered on the center frequency of the second bandpass filter 112. This output signal is preferably supplied to a voltage comparator circuit, hereinafter referred to as translator 114, preferably configured for peak detection. Preferably, translator 114 includes an operational amplifier U4, preferably in an LM311M package, as shown. The output of the LM311M is compatible with all major logic circuit types, such as TTL and RTL (at least embodying herein wherein such translator means further comprises voltage level shifter means for shifting a nominal voltage level of such at least one direct-current signal to about at least one standard logic voltage level).

Preferably, input resistor R9 provides impedance matching to the translator 114. Input resistor R9 is preferably 100 ohms with ¼ watt power dissipation capability, as shown. The operational amplifier U4 is preferably powered by nominally +5 volts and −5 volts at pins 8 and 4, respectively, as shown. The ground pin, pin 1, of the operational amplifier U4 is connected directly to ground, as shown. Preferably, the input to the translator 114 from the second bandpass filter 112 is applied to the non-inverting input (pin 2) of operational amplifier U4. Preferably, a user-adjustable reference voltage is supplied to the inverting input of operational amplifier U4 at pin 3. The reference voltage is preferably established via a front-panel variable potentiometer coupled to BAND1 (at least embodying wherein such analog to square wave converter means comprises signal amplitude selector means for holding such at least one fixed amplitude square wave signal active over at least one selected portion of the amplitude of such at least one second narrow frequency band of sound; and such at least one selected portion of the amplitude of such at least one second narrow frequency band of sound is selected by setting such settable reference voltage; and further embodying herein wherein such settable reference voltage is settable by a user wherein such translator means comprises direct-current rectifier means for outputting at least one direct-current signal corresponding to the presence of such at least one fixed amplitude square wave signal). Preferably, inverting input resistor R13 provides impedance matching into the operational amplifier U4 and assists, along with inverting input capacitor C10, in filtering out any alternating current component in the direct current reference voltage, such as ripple in the power supply. Inverting input resistor R13 is preferably sized as 1,000 ohms and ¼ watt, as shown. Inverting input capacitor C10 is preferably sized as 1 microfarad and 50 volts, as shown. The reference voltage supplied to the inverting input of operational amplifier U4 is compared with the filtered audio signal sample from the second bandpass filter 112.

Portions of the filtered audio signal sample which have a voltage with a higher amplitude than the reference voltage create a negative-going square wave at output pin 7 of operational amplifier U4. The output signal is a negative-going square wave relative to the quiescent state of the output (at least embodying herein wherein such voltage-comparator filter means comprises analog to square wave converter means for converting such at least selected narrow frequency band of sound of such at least one analog input signal to at least one fixed amplitude square wave signal). The quiescent state of the output is established by a +5 volt source dropping a voltage across resistor R6 to the output of operational amplifier U4. Preferably, the width of the square waves is determined by the user-selected reference voltage, with smaller voltages producing longer square waves. The frequency of the square waves will be the center frequency of the first and second bandpass filters 110 and 112. Preferably, the output of operational amplifier U4 is supplied to DC rectifier circuit 116. Those skilled in the art, upon reading the teachings of this specification, will appreciate that, under appropriate circumstances, considering such issues as economics, improvements in operational amplifiers, and improvement in circuit manufacturing, other translators, such as those with lower cost, adjustable resistors and capacitors, etc., may be used with filter driver board 300.

Preferably, DC rectifier circuit 116 sums and averages the square waves from the translator 114 to produce a DC logic level indicating the presence of the second bandpass filter 112 output. Any high-frequency components remaining in the square wave signal from the translator 114 are removed by shunting to ground though capacitor C7, diode D1, and capacitor C3. Capacitors C3 and C7 are preferably sized as 10 microfarads and 16 volts, as shown. Diode D1 is part number S1AB-13 from Digikey, as shown. Diodes D1 and D2, along with resistor R16 and capacitors C7 and C3, form DC rectifier 116 which sums and averages the square wave output of the translator 114 to produce a DC high level whenever the square wave is present. Preferably, the circuit components C3, C7, D1, D2, and R16 are sized to ensure that the minimum duration of the output has a desired relationship to the persistence of human vision. Specifically, the minimum trigger length should be sufficient to bring a light to the appearance of full brightness to the human eye. This prevents colors from appearing diluted or “washed out” from insufficient duration in the ON state (this arrangement at least embodies herein wherein such direct-current rectifier means comprises signal sustainer means for sustaining such at least one direct-current signal over at least one minimum ergonomic duration related to human vision persistence). The time constant, established by capacitor C3 and resistor R16, is kept short to improve reaction of the circuit to the absence of the 30 Hz signal. Resistor R16 is preferably 1000 ohms and ¼ watt power dissipation, as shown. Diode D2 is preferably part number S1AB-13 from Digikey, as shown. The DC high-level output of the DC rectifier circuit 116 has a level of about 2 volts. Preferably, the output of DC rectifier circuit 116 (at least embodying herein wherein such translator means comprises direct-current rectifier means for outputting at least one direct-current signal corresponding to the presence of such at least one fixed amplitude square wave signal) is supplied to level shifter 118. Those skilled in the art, upon reading the teachings of this specification, will appreciate that, under appropriate circumstances, considering such issues as economics, improvements in DC rectifiers and their components, and improvement in circuit manufacturing, other DC rectifiers, such as those with less ripple, lower cost, adjustable components, etc., may be used with filter driver board 300.

Preferably, level shifter 118 raises the level of the 2-volt high-level DC output from DC rectifier circuit 116 to about 4.5 volts for use in TTL or similar logic. Level shifter 118 preferably uses operational amplifier U5 in a voltage comparator configuration to shift the input level upward. Operational amplifier U5 is preferably an LM311M integrated circuit from Digikey, as shown. Preferably, the DC high-level output of the DC rectifier circuit 116 is applied to the non-inverting input of operational amplifier U5, as shown. Preferably, a fixed reference voltage, established by resistors R17 and R18 and by the +5 volts source applied thereto, is applied to the inverting input of operational amplifier U5, as shown. Preferably, resistor R17 is a 150-ohm resistor and resistor R18 is a 2200-ohm resistor, as shown. Resistors R17 and R18 are preferably sized as ¼ watt resisters, as shown. Preferably, operational amplifier U5 is powered by +5 volts and −5 volts applied to pins 8 and 4, respectively, as shown. Ground pin 1 of the operational amplifier U5 is preferably coupled directly to ground, as shown. The output of operational amplifier U5 is taken from pin 7, as shown, and supplied to current amplifier 120, as shown. Those skilled in the art, upon reading the teachings of this specification, will appreciate that, under appropriate circumstances, considering such issues as economics, improvements in operational amplifiers, and improvement in circuit manufacturing, other level shifters, such as those with higher gain, lower cost, adjustable resistors and capacitors, etc., may be used with filter driver board 300.

Current amplifier 120 (at least embodying herein current amplifier means for amplifying the current of such at least one direct-current signal having at least one standard logic voltage; wherein the output of such current amplifier means comprises such at least one trigger signal) preferably comprises transistor Q2 configured as an emitter follower. Preferably, the input signal is applied from the output of level shifter 118 through resistor R12 to the base of transistor Q2, as shown. Resistor R12 is preferably a 2200-ohm, ¼-watt resistor, as shown. Preferably, the circuit portion containing resistor R7, resistor R12, and capacitor C8 provides impedance matching and base voltage bias for transistor Q2. Resistor R7 is preferably a 1500-ohm, ¼-watt resistor, as shown. Preferably, capacitor C8 is a 2.2 microfarad, 16-volt capacitor, as shown. Emitter resistor R19 assists in stabilizing the DC operating point of the transistor Q2. The collector voltage for transistor Q2 is +5 volts. Diode D3 prevents backflow of any signal at output coupling FOUT1. Diode D3 is preferably part number S1AB-13 from Digikey, as shown. Preferably, the output signal to FOUT1 is a logic trigger (at least embodying herein at least one trigger signal) that goes high responsive to audio frequencies within the bandpass of the first and second bandpass filters 110 and 112. Those skilled in the art, upon reading the teachings of this specification, will appreciate that, under appropriate circumstances, considering such issues as economics, improvements in operational amplifiers, and improvement in circuit manufacturing, other current amplifiers, such as those with higher gain, lower cost, adjustable resistors and capacitors, etc., may be used with filter driver board 300.

Preferably, each of the five individually-tuned filter drivers 311, 312, 313, 314, and 315 on filter driver board 300 use the same circuitry except for the feedback capacitors, such as C1 and C4, in the bandpass filters, which are unique to each individually tuned filter driver 311, 312, 313, 314, or 315. This novel approach permits a large quantity of filter driver boards 300 to be initially manufactured without the feedback capacitors installed and permits a custom choice of filter driver frequencies to be made by installing such feedback capacitors responsive to market demand. For example, if a filter driver board 300 is needed for music from a brass quintet, capacitors could be installed on an otherwise complete filter driver board 300 in inventory to provide triggers for at least the center frequency of each instrument in the brass quintet. This novel approach strikes a highly economical balance between minimum manufacturing costs and customer responsiveness, because the filter driver boards 300 can be initially manufactured in very large lots and customized as desired with very little add-on labor. Those skilled in the art, upon reading the teachings of this specification, will appreciate that, under appropriate circumstances, considering such issues as economics, improvements in operational amplifiers, and improvement in circuit manufacturing, other economies may be realized, such as by pre-packaging feedback capacitor sets for easy addition to filter driver board 300, adjustable resistors and capacitors, computer-controlled adjustable resistors and capacitors, etc., may be used with filter driver board 300.

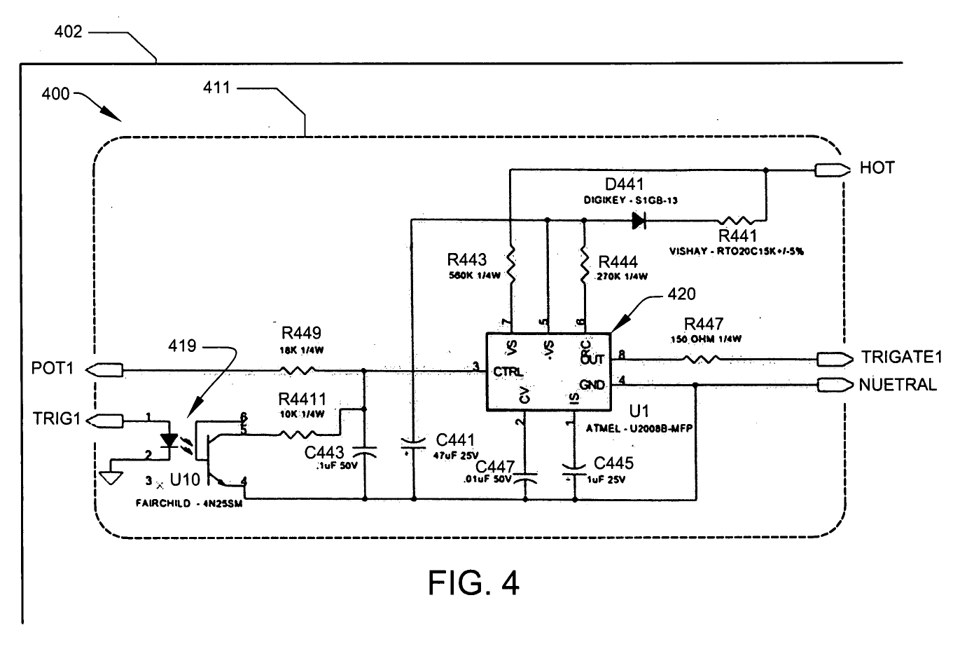

FIG. 4 shows a circuit schematic illustrating a preferred embodiment of dimmer module 400 according to the embodiment of FIG. 2b. Preferably, the trigger generated by filter driver board 300 (see FIG. 3) may be used to operate various devices in coordination with the input analog audio signals. Preferably, each individually tuned filter driver circuit 311-315 is used with a separate dimmer module 400. Preferably, dimmer modules 400 (at least embodying herein display controller means for assisting control of at least one powered entertainment display) are substantially identical to one another and there are preferably five to a dimmer module board 402. Each dimmer module is preferably coupled to an individually tuned filter driver circuit 311-315 by coupling the outputs FOUT1-FOUT5 on filter driver board 300 to inputs TRIG1-TRIG5 on dimmer modules 411-415 on dimmer module board 402, respectively (at least embodying herein a plurality of controller stages; wherein each one of such plurality of controller stages is electro-optically coupled to at least one of such plurality of frequency filter stages). The disclosure herein of an example dimmer module 411 applies to each dimmer module 411-415. Those skilled in the art, upon reading the teachings of this specification, will appreciate that, under appropriate circumstances, considering such issues as economics, improvements in operational amplifiers, and improvement in circuit manufacturing, other form factors may be realized, such as larger or smaller dimmer module boards, more or fewer dimmer modules, etc., may be used with the dimmer module board.

Preferably, dimmer module 411 receives a trigger on coupling TRIG1, as shown. Preferably, TRIG1 supplies pin 1 of a Fairchild 4N26SM optocoupler 419 (at least embodying herein at least one electro-optical coupler). Preferably, pin 2 of the optocoupler 419 is coupled directly to ground, as shown. Preferably, the trigger signal energizes a light-emitting diode (LED) in optocoupler 419 between pin 1 and pin 2. Energy from the LED is sensed by a photodetecting transistor connected to pins 4, 5, & 6, causing it to conduct, and the resulting output signal is supplied on pins 4 and 5 of optocoupler 419, as shown. Preferably, the output of optocoupler 419, a logic high when the desired audio frequencies have been detected by the filter driver circuit 311, is coupled to pins 3 and 4 of phase control integrated circuit U1 (hereinafter refered to as phase control integrated circuit IC 420), as shown. Preferably, phase control IC 420 has a soft start capability. Phase control IC 420 is preferably an ATMEL U2008B-MFP, as shown. Pin 3 of the phase control IC 420 is the control input, which is preferably used to determine the point in time at which the output trigger of the phase control IC 420 is generated. Preferably, pin 4 of the phase control IC 420 is the ground pin, which is also coupled to the board ground at NEUTRAL, as shown. Preferably, the voltage at pin 3 of the phase control IC is biased by an input voltage from POT1, which is preferably a front panel potentiometer that the user can adjust to establish the set point for the control input (this arrangement embodies herein providing at least one direct-current reference voltage having at least one direct-current trigger voltage superimposed therein; wherein such at least one direct-current trigger voltage is supplied by optical coupling from at least one external trigger source; and wherein such at least one direct-current reference voltage is adjustable by a user). Preferably, resistor R449 drops the input voltage from POT1 at the input to pin 3 of the phase control IC 420. Resistor R449 is preferably an 18,000-ohm, ¼ watt resistor, as shown. Resistor R4411 is the collector resistor for the optocoupler 419. Accordingly, the signal at the control input to the phase control IC 420 is a voltage determined by the potentiometer setting and the conduction state of the optocoupler 419. Preferably, capacitor C443 provides a path to ground for AC components in the bias voltage and some ramping of the optocoupler output. Preferably, capacitor C443 is a one microfarad, 50-volt capacitor, as shown. Those skilled in the art, upon reading the teachings of this specification, will appreciate that, under appropriate circumstances, considering such issues as economics, ergonomics, and devices to be controlled, other modules, such as motor controllers, fountain controllers, and laser controllers, etc., may be used with dimmer module board 402.

The main supply voltage being controlled by the circuit is an AC voltage that may be as high as 230 volts and is available at the coupling on dimmer module board 402 labeled HOT. Preferably, the supply voltage is supplied to pin 7 of phase control IC 420 for use in voltage synchronization with the main supply voltage compensation that takes place internal to phase control IC 420. Resistor R443, which is in the path from the main voltage supply to pin 7 of phase control IC 420, is preferably sized as 500,000 ohms and ¼ watts, as shown. Preferably, voltage is supplied to pin 5 of phase control IC through negative half-wave rectifier diode D441 and resistor R441, as shown. Pin 5 is the −Vₛ power supply to phase control IC 420. Preferably, capacitor C441 provides smoothing of the half-wave rectified voltage. Diode D441 is preferably part S1GB-13 from Digikey, as shown. Resistor R441 is preferably a VISHAY-RTO20C15K+/−5%, as shown. Capacitor C441 is preferably sized as 47 microfarads, 25 volts, as shown. Resistor R444 drops a portion of the −Vₛ voltage to pin 6 of the phase control IC for phase control. In the preferred embodiment, resistor R444 is constant at 270,000 ohms and ¼ watts, enabling phase control through the output of optocoupler 419. Preferably, the phase angle of the output trigger at pin 8 is determined by the relationship of the voltage at pin 2 with the voltage at pin 3. Preferably, resistor R444 determines the charging rate of capacitor C447, which determines the steepness of the ramp of the voltage at pin 2. With resistor R444 constant, the voltage ramp at pin 2 has the same steepness each time, but the voltage at pin 3 varies depending on the output of the optocoupler 419 and the setting of the potentiometer coupled to POT1, as previously discussed. Accordingly, the phase of the output trigger at TRIGATE1 is preferably controlled by the input trigger pulse for a given potentiometer POT1 setting. Those skilled in the art, upon reading the teachings of this specification, will appreciate that, under appropriate circumstances, considering such issues as circuit timing, various desired phase relationships, and improvement in circuit manufacturing, other phase control approaches could be implemented, such as using a variable resistance at the input of pin 6, influence the pin 6 voltage directly with the input trigger, etc., may be used with dimmer module board 402.

Preferably, pin 1 of phase control IC 420 is used for load current sensing. Capacitor C445 preferably determines the soft start characteristics of the circuit. Capacitor C445 is preferably sized as 4.7 microfarads and 25 volts, as shown. Preferably, the output of phase control IC 420 is a trigger for triac 432 coupled to the board output TRIGATE1. Resistor R447 provides current limiting to the triac gate. Resistor R447 is preferably 150 ohms and ¼ watt, as shown. In a preferred embodiment, triac 432 energizes one or more lights when the gate is triggered. Triac 432 may preferably use the same main supply voltage as dimmer module 402. Those skilled in the art, upon reading the teachings of this specification, will appreciate that, under appropriate circumstances, considering such issues as economics, stylistic considerations, and special effects production considerations, other sub-circuits may be included in the triac load circuit, such as marquee chasers, strobe generators, color-relational cross connections between dimmer modules 400, etc., may be used with dimmer module board 402.

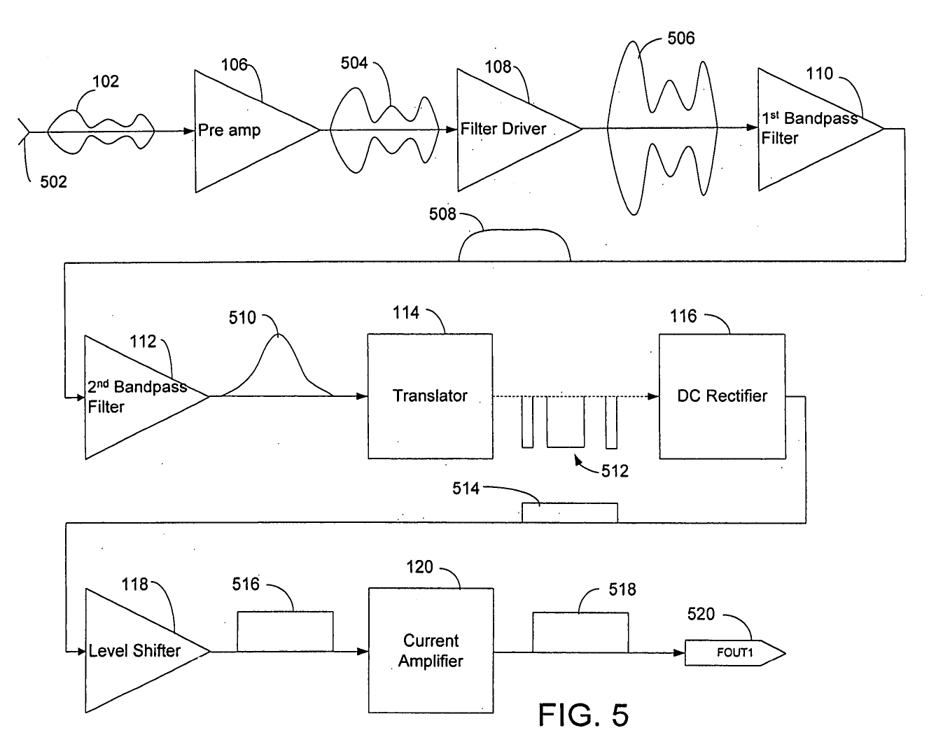

FIG. 5 is a block diagram illustrating the filter driver circuit and the wave forms produced by each component or sub-circuit. An audio signal 102 comes into the circuit at the audio input jack 502. Preferably, pre-amp 106 receives the input audio signal 102 and amplifies it by a gain of about 2 to produce inverted signal 504, as shown. Preferably, filter driver 108 receives amplified inverted signal 504 and amplifies it by a gain of about 5 to produce driver audio signal 506, as shown. Preferably, the driver audio signal 506 is filtered by first bandpass filter 110, which produces filtered audio sample 508 (if driver audio signal 506 contains frequencies within the bandwidth of the first bandpass filter 110). Preferably, filtered audio signal 508 is filtered in second bandpass filter 112 to produce a higher-Q audio sample 510. Higher-Q audio sample 510 is preferably supplied to translator 114, which produces negative-going square wave 512 of fixed amplitude with the wavelength proportional to the width of higher-Q audio sample 510 at its half-power points, or other fractional power points selected by user adjustment. Preferably, negative-going square wave 512 is supplied to DC rectifier 116, where the square waves are summed and averaged to an output level 514 having an ergonomic duration related to human vision persistence and color perception. Preferably, output level 514 is supplied to level shifter 118, which produces TTL high-level pulse 516 having the same ergonomic duration. Preferably, TTL high-level pulse 516 is supplied to current amplifier 120, which produces a higher powered TTL high-level pulse 518 to output 520.

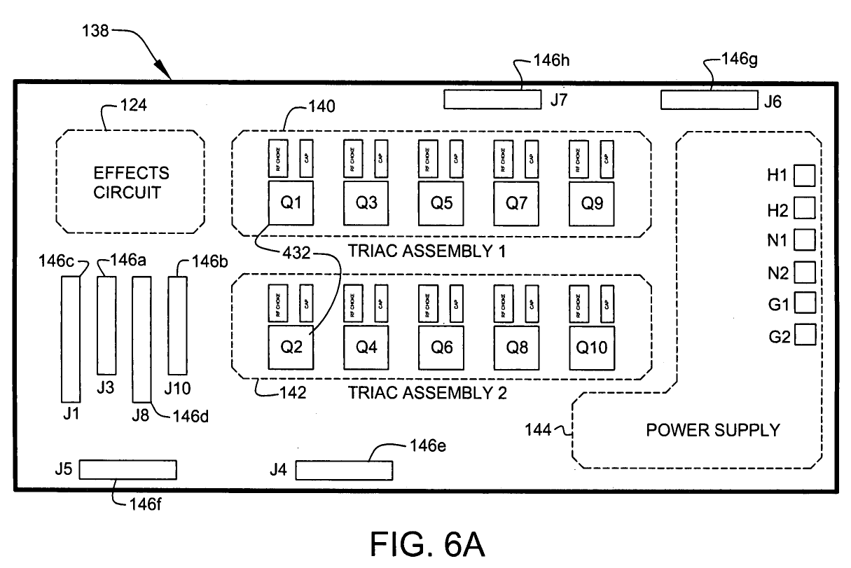

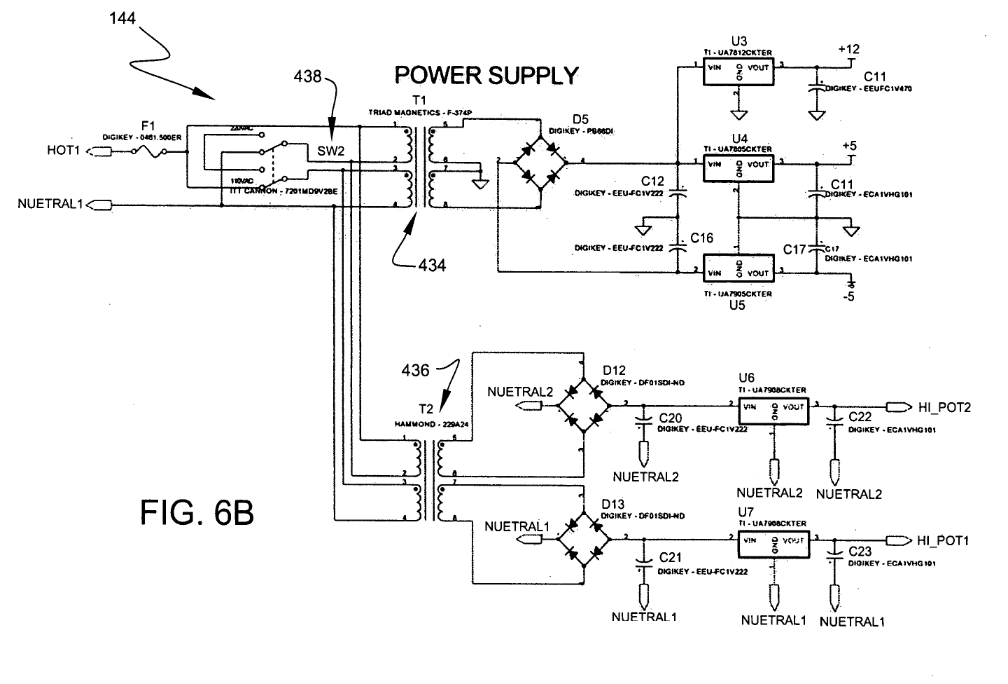

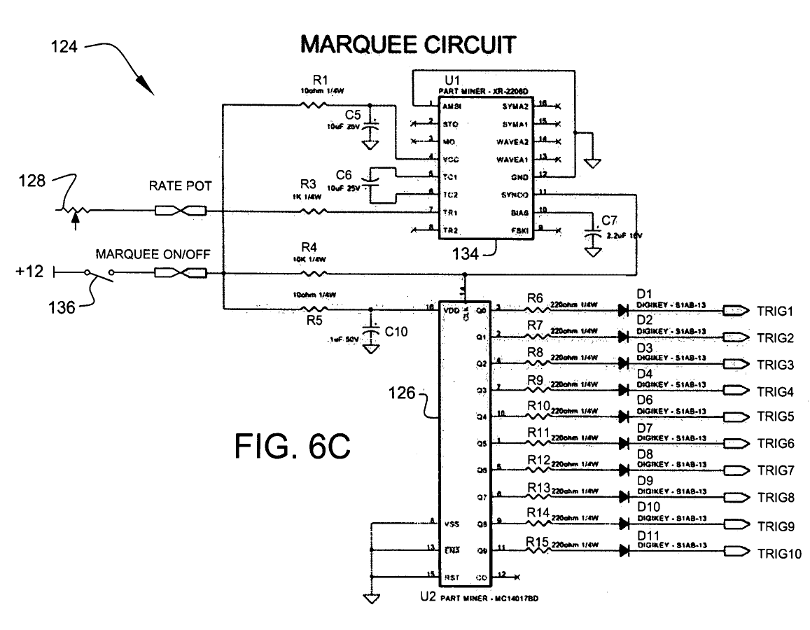

FIG. 6a shows a diagram illustrating a preferred embodiment of system motherboard 138 according to the embodiment of FIG. 1. Preferably, system motherboard 138 comprises effects circuit 124, first triac assembly 140, second triac assembly 142, power supply 144, and edge connectors 146a-146h.

Preferably, edge connectors 146a (J3) and 146b (J10) permits system motherboard 138 to removably couple with a first and second filter driver board 300 respectively. Similarly, edge connectors 146c (J1) and 146d (J8) preferably permit system motherboard 138 to removably couple with a first and second dimmer module board 402 respectively.

Preferably, edge connector 146e (J4) and edge connector 146f (J5) permits system motherboard 138 to couple with front panel board 150. Similarly, edge connector 146g (J6) and edge connector 146h (J7) permits system motherboard 138 to couple with back panel board 152.

The preferred modular architecture of audio display system 100 permits convenient modification to the frequency discrimination characteristics of the system. Preferably, by removing and replacing the modular circuit boards on system motherboard 138, audio display system 100 can be matched to particular kinds of musical sounds or a specific music source, thus maximizing visual interest at the electrically powered entertainment display.

Preferably, first triac assembly 140 and second triac assembly 142 each comprise a bank of five general purpose triacs 432, preferably model NTE5608 manufactured by NTE Electronic Inc. of Bloomfield, N.J., as shown. Preferably, a choke and capacitor are used to reduce RF noise at the circuit. Preferably, the triac trigger gates designated TRIGATE1 through TRIGATE5 are electrically coupled to pins 12 through 16 at edge connectors 146c (J1), as shown. Preferably, the triac trigger gates designated TRIGATE6 through TRIGATE10 are electrically coupled to pins 12 through 16 at edge connectors 146d (J8). Preferably, triac current supplied terminals OUT1 through OUT10 are electrically respectively coupled to pins 11 through 1 at edge connector 146h (J7) serving back panel board 152.

FIG. 6b shows a schematic diagram illustrating power supply 144 of system motherboard 138 according to the preferred embodiment of FIG. 6a. Power supply 144 preferably comprises a pair of dual primary transformers coupled to a series of rectifier/regulator circuits, as shown. Voltage switch 438 (SW2) permits selection of the incoming voltage (110v or 220v), routing the current to the appropriate primary inputs at the transformers.

Preferably, transformer 434 (T1) is coupled to bridge rectifier D5, as shown. Preferably, bridge rectifier D5 is coupled to three voltage regulators, as shown. Smoothing is performed by electrolytic capacitors connected across the DC supply, as shown. Preferably, regulators U3, U4, and U5 respectively supply +12v DC, +5v DC, and −5v DC, as shown.

Preferably, transformer 436 (T2) is used to supply a pair of bridge rectifiers, D12 and D13, as shown. Preferably, bridge rectifier D12 is coupled to voltage regulator U6, as shown. Preferably, bridge rectifier D13 is coupled to voltage regulator U7, as shown. Smoothing for the circuits is performed by capacitors C20 and C21, as shown. Preferably, both voltage regulator U6 and voltage regulator U7 supply a fixed −8v at coupling HI_POT2 and coupling HI_POT1, respectively. Preferably, the output voltage at HI_POT1 and HI_POT2 supply the front panel dimmer potentiometers.

FIG. 6c shows a schematic diagram illustrating effects circuit 124 of system motherboard 138 according to the embodiment of FIG. 6a. Preferably, effects circuit 124 (at least embodying herein at least one controllable effects generator adapted to generate at least one controllable illumination effect at the at least one illumination source) is assembled using decade counter 126 and clock generator 134, as shown. Preferably, decade counter 126 comprises a five-stage Johnson-type decade counter, preferably model MC14017BD manufactured by On Semiconductor Components Industries, LLC, of Denver, Colo., U.S.A. The ten signal outputs (Q0 through Q9) of decade counter 126 are normally low, and go high, only at their appropriate decimal time period, with the output changes corresponding to the incoming clock pulses from clock generator 134. Preferably, clock generator 134 comprises a function generator integrated circuit model XR-2206D, preferably as manufactured by Exar Corporation of Fremont Calif., U.S.A. Preferably, the frequency of oscillation, fo, of clock generator 134, is determined by a fixed value external timing capacitor, C6, across Pin 5 and 6, and by the resistance value provided by rate potentiometer 128 (RATE POT) coupled to Pin 7, as shown. Taking C to be the value of C6 and R to equal the total resistance returned from rate potentiometer 128, the relevant parameters governing the timing of clock generator 134 frequency are given as: fo=1/RC Hz.

Preferably, the square wave output from pin 11 (SYNCO) of clock generator 134 is coupled to the clock pin 14 of decade counter 126, as shown. Actuation of effects circuit 124 is provided by marquee switch 136 (designated MARQUEE ON/OFF) preferably located at front panel board 150, as shown (at least embodying herein wherein such at least one controllable effects generator comprises at least one user control adapted to permit user initiated control of at least one feature of such at least one controllable illumination effect). When closed, marquee switch 136 supplies +12v DC to the circuit thus bypassing the timing logic of clock generator 134.

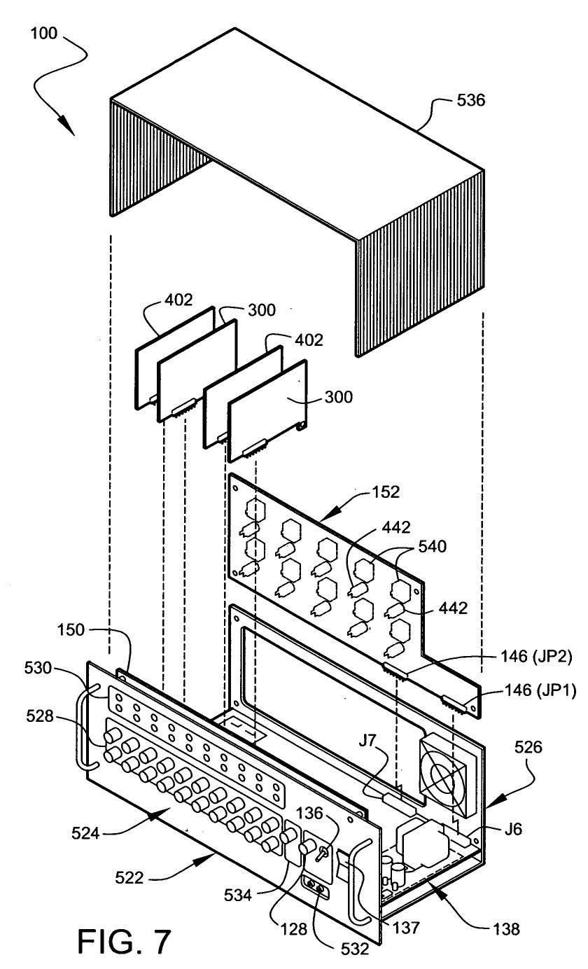

FIG. 7 shows an exploded view generally illustrating the modular components of audio display system 100 according to the entertainment display setup of FIG. 1. A preferred embodiment of audio display system 100 comprises a self-contained unit suitable for transport and set-up by a single user. Preferably, housing 522 provides a protective supporting structure for system motherboard 138 and a plurality of circuit modules removably mountable to system motherboard 138, as shown. Preferably, housing 522 comprises a rack-mountable format, as shown. Upon reading the teachings of this specification, those with ordinary skill in the art will now understand that, under appropriate circumstances, considering such issues as intended use, user preference, etc., case formats, such as table mounted, wall mounted, etc., may suffice.

Preferably, housing 522 comprises front panel 524 and rear panel 526, as shown. Preferably, front panel 524 comprises display control section 528, indicator section 530, audio inputs 532, audio input level control 534, main power switch 137, and effects control section 536, as shown.

Preferably, display control section 528 comprises a bank of ten band potentiometers, and ten dimmer potentiometers, as shown. Preferably, each band potentiometer is coupled to a filter driver (see FIG. 3) to permit user setting of the reference voltage at a translator 114. Preferably, each dimmer potentiometer is coupled with a dimmer module 400 (for example POT1 as described in FIG. 4) to permit a user to bias the input voltage at pin 3 of phase control IC 420.

Preferably, indicator section 530 comprises a series of ten red LEDs, each coupled to the indicator output of a second bandpass filter 112 of a single filter driver, and ten green LEDs each coupled between a filter driver output and its associated dimmer module. Preferred indication functions of indicator section 530 are as described in FIG. 3 and FIG. 4.

Preferably, audio inputs 532 comprise a pair of RCA connectors, as shown. Preferably, each RCA connector is coupled to one of the pair of filter driver boards 300 installed in audio display system 100, as shown. In a typical operational arrangement, the right and left channels of an analog stereo signal may be separately assigned to one of the two RCA connectors of audio inputs 532, as shown.

Audio level control at audio inputs 532 is provided by audio input level control 534, preferably comprising an audio taper potentiometer electrically coupled in-line with the RCA connectors of audio inputs 532.

Preferably, effects control section 536 comprises rate potentiometer 128, coupled to clock generator 134 of effects circuit 124, and marquee switch 136 coupled to decade counter 126.

Preferably, the functional components of front panel 524 are mounted to front panel board 150, as shown. Preferably, front panel board 150 is situated behind front panel 524 and removably engages system motherboard 138 using a pair of edge connectors 146 (J4) and (J5).

Preferably, back panel board 152 is positioned adjacent rear panel 526 and electrically engages system motherboard 138 using a matching pair of edge connectors J6/JP1 and J7/JP2. Preferably, back panel board 152 comprises ten power connector outlets 540, as shown. Preferably, each power connector outlet 540 is coupled to a triac 432 located on motherboard 138. Preferably, each power connector outlet 540 is protected against over current by fuse 442, as shown. Upon reading the teachings of this specification, those of ordinary skill in the art will now understand that, under appropriate circumstances, considering such issues as system component selection, intended use, etc., the use of other system components, such as cooling fans, heat sinks, power busses, etc., may suffice.

Preferably, system motherboard 138 is adapted to removably receive two separate filter driver boards 300 (at least embodying herein wherein such plurality of frequency filter stages comprises a physically separate modular circuit board) using edge connectors 146. As previously described, each filter driver board 300 comprises five filter driver stages (at least embodying herein wherein each physically separate modular circuit board comprises at least five of such plurality of frequency filter stages). Preferably, system motherboard 138 is also adapted to removably receive two separate dimmer module board 402 (at least embodying herein wherein such plurality of controller stages comprises a physically separate modular circuit board). As previously described, each dimmer module board 402 preferably comprises five dimmer modules 400 (at least embodying herein wherein such physically separate modular circuit board comprises at least five of such plurality of controller stages). Preferably, housing 522 is adapted to provide access to the modular components of audio display system 100 by means of, for example, removable cover 536, as shown.

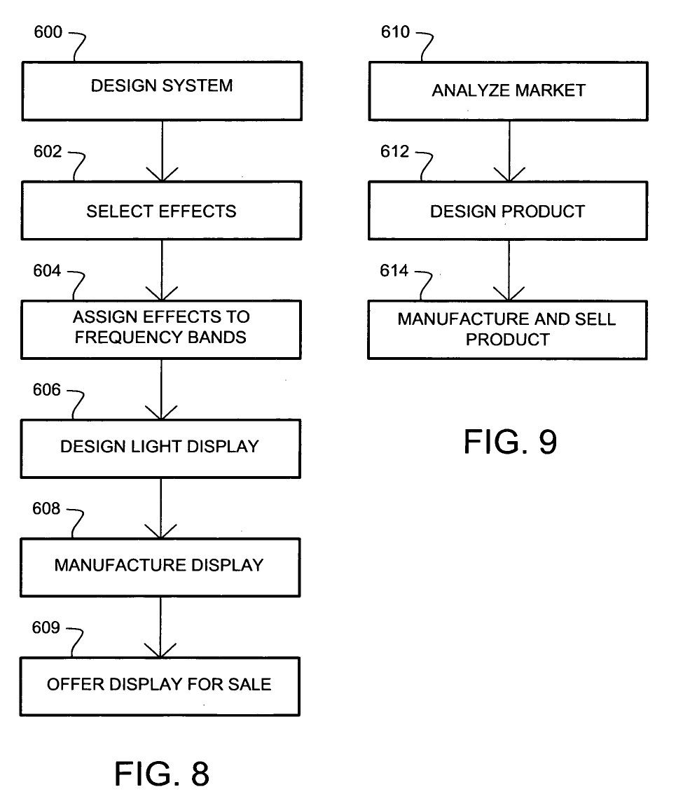

FIG. 8 shows a diagram illustrating a method, relating to modular design to produce pleasurable visual effects responsive to analog music sounds, according to the present invention. According to a preferred method, a supplier designs an audio display system comprising at least one modular electronic architecture providing filtering of analog music sounds into at least five narrow frequency bands by at least five frequency-selectable filtering circuits, as indicated in step 600. Preferably, each of the five frequency-selectable filtering circuits comprise essentially the same circuits but for frequency-selecting values of specific sub-components. Further, essentially all of the electronic components used in the design of the modular architecture preferably comprise standard off-the-shelf electronic components.

Preferably, the supplier selects at least five different visual effects, at indicated in step 602, each effect designed to be triggerable by the presence of selectable minimums of sound narrowly adjacent at least one selected sound frequency. In subsequent step 604, the supplier assigns each visual effect of the five different visual effects to at least one of the five narrow frequency bands. The preferred modularity of the electronic architecture assists ease of variability in selecting and assigning the least five narrow-frequency bands to maximize visual interest from a variety of unique musical sounds. In a preferred application of the present invention, the at least five different visual effects comprise selected colors of light. Preferably, the triggerability of audio display system is specifically designed, working within parameters of human visual systems, to produce essentially only light pulses of sufficient length to be seen as a full-color effect and brightness for each such selected color of light. Preferably, the at least five narrow-frequency bands are selected to correlate with at least one fundamental frequency of at least one source of musical sound. In preferred embodiments of the present invention, the source of musical sound comprises one or more musical instruments.

In subsequent preferred step 606, the supplier designs at least one light display matched for plug-in use with the at least one modular electronic architecture of the audio display system. Preferably, the supplier then manufactures, based on the design, the audio display system, and the associated light display as indicated in step 608.

On manufacturing an adequate number of units, the supplier offers the audio display system and light display for sale to businesses desiring a professional-quality color organ as indicated in step 609. The preferred use of analog filtering and standard off-the-shelf electronic components permits the audio display system to be offered at non-custom pricing. Most preferably, the supplier offers the audio display system for sale to musical entertainment sources providing instant selectability of musical numbers.

FIG. 9 shows a diagram illustrating a method, relating to producing pleasurable visual effects responsive to analog music sounds. Preferably, a supplier analyzes at least one entertainment market desiring digital-quality sound separation devices adaptable to a wide variety of analog musical pieces and buyable within analog, non-custom pricing as indicated in step 610. Preferably, the supplier designs a plurality of entertainment products each utilizing at least one essentially-analog sound separation device using essentially off-the shelf circuit components and providing essentially digital-quality sound separation as indicated in step 612. Preferably, the supplier's design uses modular design and manufacturing techniques to provide a variety of different price ranges for the entertainment products. Preferably, each of the essentially-analog sound separation devices comprises filtering distinguishing at least five different narrow-frequency bands.

Preferably, the supplier then manufactures and sells the entertainment products as indicated in step 614. Most preferably, the entertainment products comprise color organs. Upon reading the teachings of this specification, those of ordinary skill in the art will now understand that, under appropriate circumstances, considering such issues as user preference, intended use, etc., the entertainment products may comprise a diverse range of products, such as, musically synchronized holiday lighting, musically synchronized animatronic characters, musically synchronized fireworks launchers, musically synchronized laser projectors, etc.

Although applicant has described applicant's preferred embodiments of this invention, it will be understood that the broadest scope of this invention includes such modifications as diverse shapes and sizes and materials. Such scope is limited only by the below claims as read in connection with the above specification.

Further, many other advantages of applicant's invention will be apparent to those skilled in the art from the above descriptions and the below claims.

What is claimed is:

1) Circuit apparatus, relating to providing, from at least one analog input signal comprising at least one wide frequency band of sound, at least one trigger signal corresponding to presence of at least one selected narrow frequency band of sound, comprising:
a) at least one analog receiver adapted to receive such at least one wide frequency band of sound;
b) at least one first band pass filter adapted to filter such at least one wide frequency band of sound to select at least one first narrow frequency band of sound having a wider band than at least one second narrow frequency band of sound;
c) at least one second band pass filter adapted to filter such at least one first narrow frequency band of sound to select such at least one second narrow frequency band of sound having a wider band than such at least one selected narrow frequency band of sound;
d) at least one voltage-comparator filter, having at least one settable reference voltage usable to further narrow such at least one second narrow frequency band of sound, adapted to filter by voltage comparator to select such at least selected narrow frequency band of sound; and
e) at least one translator circuit adapted to provide, for use as such at least one trigger signal, at least one direct-current signal corresponding to such presence of such at least one selected narrow frequency band of sound.

2) The circuit apparatus according to claim 1 further comprises:
a) a plurality of frequency filter stages electrically coupled to said at least one analog receiver;
b) wherein each one of said plurality of frequency filter stages comprises
i) said at least one first band pass filter,
ii) said at least one second band pass filter,
iii) said at least one voltage-comparator filter, and
iv) said at least one translator circuit; and
c) wherein each one of said plurality of frequency filter stages is adapted to provide at least one additional trigger signal corresponding to presence of at least one additional selected narrow frequency band of sound.

3) The circuit apparatus according to claim I wherein said at least one voltage-comparator filter comprises at least one analog to square wave converter adapted to convert such at least selected narrow frequency band of sound of such at least one analog input signal to at least one fixed amplitude square wave signal.

4) The circuit apparatus according to claim 3 wherein said at least one analog to square wave converter comprises:
a) at least one signal amplitude selector adapted to hold such at least one fixed amplitude square wave signal active over at least one selected amplitude portion of such at least one second narrow frequency band of sound;
b) wherein such at least one selected amplitude portion of such at least one second narrow frequency band of sound is selected by setting such settable reference voltage.

5) The circuit apparatus according to claim 4 wherein such settable reference voltage is settable by a user.

6) The circuit apparatus according to claim 3 wherein said at least one translator circuit comprises at least one direct-current rectifier adapted to output at least one direct-current signal corresponding to the presence of such at least one fixed amplitude square wave signal.

7) The circuit apparatus according to claim 6 wherein said at least one direct-current rectifier comprises at least one direct-current signal sustainer adapted to sustain such at least one direct-current signal over at least one minimum ergonomic duration related to human vision persistence.

8) The circuit apparatus according to claim 6 wherein said at least one translator circuit further comprises at least one voltage level shifter adapted to shift a nominal voltage level of such at least one direct-current signal to about at least one standard logic voltage level.

9) The circuit apparatus according to claim 6 wherein said at least one translator circuit further comprises at least one voltage level shifter adapted to shift a nominal voltage level of such at least one direct-current signal to a transistor-transistor logic level of more than about three volts and less than about six volts.

10) The circuit apparatus according to claim 8 wherein said at least one translator circuit further comprises:
a) at least one current amplifier adapted to amplify the current of such at least one direct-current signal having at least one standard logic voltage;
b) wherein the output of said at least one current amplifier comprises such at least one trigger signal.

11) The circuit apparatus according to claim 2 wherein said at least one analog receiver comprises at least one preamplifier adapted to pre-amplify such at least one analog input signal from a line level to a first output gain prior to frequency filtering.

12) The circuit apparatus according to claim 11 wherein said at least one analog receiver further comprises at least one filter driver adapted to amplify such at least one analog input signal from such first output gain to a second output gain compatible with the operation of said at least one first band pass filter.

13) The circuit apparatus according to claim 11 further comprising:
a) at least one display controller adapted to provide electrical control of at least one powered entertainment display;
b) wherein electrical control of the at least one powered entertainment display by said at least one display controller is triggerable by such at least one trigger signal.

14) The circuit apparatus according to claim 13 wherein said at least one display controller comprises at least one phased controlled integrated circuit adapted to regulate at least one flow of electrical current to such at least one powered entertainment display.

15) The circuit apparatus according to claim 13 wherein said at least one display controller comprises at least one electro-optical coupler adapted to receive the at least one trigger signal by electro-optical coupling.

16) The circuit apparatus according to claim 15 wherein said at least one display controller is adapted to electrically control the illumination of at least one illumination source.

17) The circuit apparatus according to claim 16 further comprising:
a) a plurality of controller stages;
b) wherein each one of said plurality of controller stages is electro-optically coupled to at least one of said plurality of frequency filter stages; and
c) wherein each one of said plurality of controller stages is adapted to provide electrical control of at least one powered entertainment display in response to the at least one trigger signal generated by said at least one of said plurality of frequency filter stages.

18) The circuit apparatus according to claim 17 wherein:
a) each one of said plurality of controller stages is adapted to electrically control said at least one illumination source; and
b) said at least one illumination source comprises a visually distinct color.

19) The circuit apparatus according to claim 15 wherein said at least one display controller further comprises:
a) at least one controllable effects generator adapted to generate at least one controllable illumination effect at the at least one illumination source;
b) wherein said at least one controllable effects generator comprises at least one user control adapted to permit user initiated control of at least one feature of such at least one controllable illumination effect.

20) The circuit apparatus according to claim 19 wherein said at least one controllable effects generator comprises:
a) at least one decade counter adapted to provide at least one logic pulse;
b) wherein said at least one decade counter is structured and arranged to control said plurality of controller stages in at least one serial order to provide at least one sequenced illumination effect.

21) The circuit apparatus according to claim 17 wherein said plurality of controller stages comprises a physically separate modular circuit board.

22) The circuit apparatus according to claim 21 wherein said physically separate modular circuit board comprises at least five of said plurality of controller stages.

23) The circuit apparatus according to claim 2 wherein said plurality of frequency filter stages comprises a physically separate modular circuit board.

24) The circuit apparatus according to claim 22 wherein each physically separate modular circuit board comprises at least five of said plurality of frequency filter stages.

25) A method of providing a trigger voltage to a phased controlled integrated circuit adapted to power at least one entertainment display system, comprising the steps of:
a) providing at least one direct-current reference voltage having at least one direct-current trigger voltage superimposed therein;
b) wherein such at least one direct-current trigger voltage is supplied by optical coupling from at least one external trigger source; and
c) wherein such at least one direct-current reference voltage is adjustable by a user.

26) A method, relating to modular design to produce pleasurable visual effects responsive to analog music sounds, comprising the steps of:
a) designing at least one modular electronic architecture providing filtering of such analog music sounds into at least five narrow frequency bands by at least five frequency-selectable filtering circuits;
b) wherein each of such at least five frequency-selectable filtering circuits comprise essentially the same circuits but for frequency-selecting values; and
c) wherein essentially all electronic components used in such designing of such at least one architecture comprise standard off-the-shelf electronic components; and
d) selecting at least five different visual effects, each designed to be triggerable by presence of selectable minimums of sound narrowly adjacent at least one selected sound frequency; and
e) assigning each visual effect of such at least five different visual effects to at least one of such at least five narrow frequency bands;
f) wherein such at least one modular electronic architecture assists ease of variability in assigning such at least five narrow-frequency bands to maximize visual pleasure from each of a variety of particular kinds of music sounds.

27) The method according to claim 26 wherein such at least five different visual effects comprise selected colors of light.

28) The method according to claim 27 wherein such triggerability is designed, working within parameters of human visual systems, to produce essentially only light pulses of sufficient length to be seen as a full-color effect and brightness for each such selected color of light.

29) The method according to claim 26 wherein such at least five narrow-frequency bands are selected to correlate with at least one fundamental frequency of at least one source of musical sound.

30) The method according to claim 29 wherein such at least one source of musical sound comprises at least one musical instrument.

31) The method according to claim 26 further comprising the step of designing at least one light display matched for plug-in use with such at least one modular electronic architecture.

32) The method according to claim 30 further comprising the step of designing at least one light display matched for plug-in use with such at least one modular electronic architecture.

33) The method according to claim 32 further comprising the step of manufacturing such designed at least one modular electronic architecture and such at least one light display.

34) The method according to claim 33 further comprising the step of offering such manufactured such designed at least one modular electronic architecture and such at least one light display for sale to businesses desiring a professional-quality color organ at non-custom pricing.

35) The method according to claim 34 wherein such businesses comprise musical entertainment sources providing instant selectability of musical numbers.

36) The method according to claim 26 further comprising the step of manufacturing such designed at least one modular electronic architecture.

37) A method, relating to producing pleasurable visual effects responsive to analog music sounds, comprising the steps of:
a) analyzing at least one entertainment market desiring digital-quality sound separation devices adaptable to a wide variety of analog musical pieces and buyable within analog, non-custom pricing; and
b) designing a plurality of entertainment products each utilizing at least one essentially-analog sound separation device using essentially off-the shelf circuit components and providing essentially digital-quality sound separation;
c) wherein such designing uses modular design and manufacturing techniques to provide a variety of different price range such entertainment products; and
d) wherein each such at least one essentially-analog sound separation device comprises filtering distinguishing at least five different narrow-frequency bands.

38) The method according to claim 37 further comprising manufacture and sale of such entertainment products.

39) The method according to claim 38 wherein such entertainment products comprise color organs.
